(19) United States
(12) Patent Application Publication
(10) Pub. No.: US 2009/0048798 A1
(43) Pub. Date: Feb. 19, 2009

(54) Method for Performing Write Calibrations on Holographic Storage Media

(76) Inventors: Allen Keith Bates, Tucson, AZ (US); Nils Haustein, Soergenloch (DE); Craig A. Klein, Tucson, AZ (US); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/839,283

(22) Filed: Aug. 15, 2007

(51) Int. Cl. G06F 19/00

(52) U.S. Cl. 702/86

(57) ABSTRACT

A method for performing write calibrations on holographic storage media is disclosed. Initially, five identical and known calibration holograms are written on a holographic storage medium, in which three of the five calibration holograms are written with different laser power and three of the five calibration holograms are written with different time durations. A matched filter is then utilized to determine a cross-correlation between the five calibration holograms read from the holographic storage medium and their corresponding ideal calibration holograms previously stored within a memory device within the holographic storage drive. A least-squares fit of an ellipsoidal parabola to the cross-correlations is subsequently calculated to yield an optimal laser write power level and an optimal duration for a laser write pulse.

### BACKGROUND OF THE INVENTION

1. Technical Field

The present invention relates to optical storage media in general, and more particularly, to holographic storage media. Still more particularly, the present invention relates to a method for performing write calibrations on holographic storage media.

2. Description of Related Art

Various types of optical storage devices along with their corresponding optical storage media had been developed since the 1980s. Thus, there is a variety of optical storage devices currently in use in commerce, ranging from legacy devices such as the 3363 write-once read-many (WORM) drives by International Business Machines Corporation of Armonk, N.Y., to state of art devices such as the 3995 Optical Data Servers also by International Business Machines Corporation.

Since some of the legacy optical storage devices and optical storage media are still in use, it is incumbent upon the optical storage device manufacturers to provide support for those optical storage media, for the preservation of customer data and to support data recovery operations.

The present disclosure provides a method for enhancing the writing of data stored on holographic storage medium, such that the written data can be more readable when its retrieval is required.

### SUMMARY OF THE INVENTION

In accordance with a preferred embodiment of the present invention, five identical and known calibration holograms are written on an holographic storage medium, in which three of the five calibration holograms are written with different laser power and three of the five calibration holograms are written with different time durations. A matched filter is then utilized to determine a cross-correlation between the five calibration holograms read from the holographic storage medium and the corresponding ideal calibration hologram previously stored within the memory of the holographic storage drive itself. A least-squares fit of an ellipsoidal parabola to these cross-correlations is calculated, to yield an optimal laser write power and an optimal duration for a laser write pulse.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 illustrates an holographic storage device having a holographic-write path, in accordance with a preferred embodiment of the present invention;

FIG. 2 is a high-level logic flow diagram of a method for performing a write-calibration on an holographic storage medium, in accordance with a preferred embodiment of the present invention; and

FIG. 3 graphically depicts a three-dimensional ellipsoidal parabola for least-squares fitting to the cross-correlations of five calibration holograms read from the holographic media to an ideal calibration hologram.

### DETAILED DESCRIPTION OF A PREFERRED EMBODIMENT

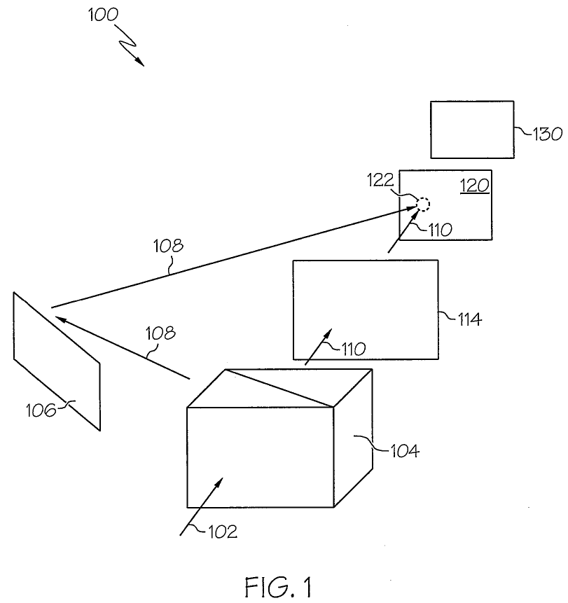

With reference now to the drawings, and in particular to FIG. 1, there is graphically illustrated a holographic storage device having a holographic-write path, in accordance with a preferred embodiment of the present invention. As shown, a holographic storage device 100 includes a beam splitter 104 for splitting an incoming laser light 102 into a reference beam 108 and a signal beam 110. Reference beam 108 reflects off a first surface mirror 106 and reaches a holographic storage media 120. After passing through a transmissive spatial light modulator (SLM) 114, signal beam 110 becomes encoded with data and impinges upon holographic storage media 120.

Laser light 102 maybe a blue light at a wavelength of 405 nm, a green light at a wavelength of 514 or 532 nm, a red light at a wavelength of 650 nm, or an infrared light at a wavelength of 780 nm. Laser light 102 may also be a light at a wavelength tuned to the recording and/or reading characteristics of holographic storage media 120.

Signal beam 110 and reference beam 108 intersect at holographic storage media 120 to produce an interference pattern, called calibration hologram 122, on holographic storage media 120. Hologram 122 may alternately represent a data hologram for the storage of 2 0 customer data. Holographic storage media 120 may either be transmissive, where the optical detector is on the opposite side of the media 120 as laser light 102, or reflective, where the optical detector is on the same side of the media 120 as laser light 102.

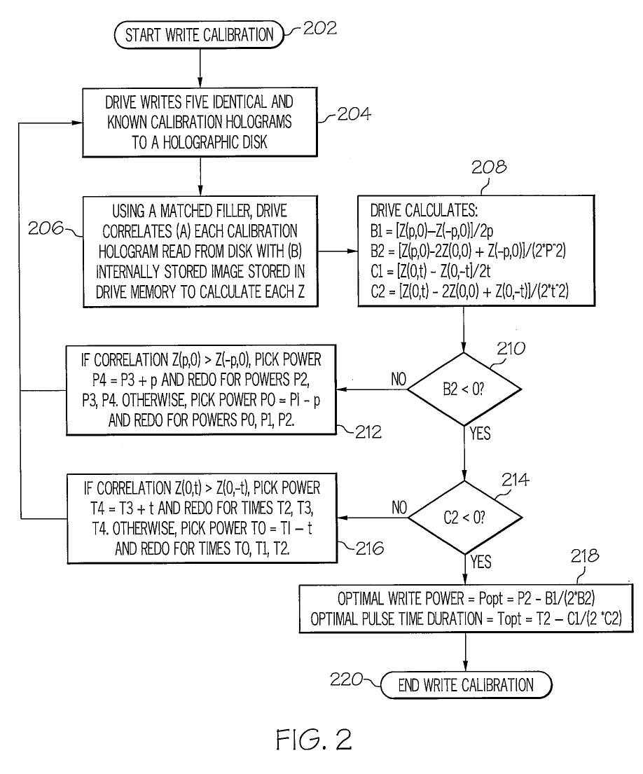

With reference now to FIG. 2, there is depicted a high-level logic flow diagram of a method for performing a write-calibration on a holographic storage medium, in accordance with a preferred embodiment of the present invention. After a write calibration process has begun, as shown in block 202, five identical calibration holograms are successively written to a holographic storage media at three equidistant power levels and three equidistant time-durations, as depicted in block 204. For example, a calibration hologram, such as calibration hologram 122 from FIG. 1, can be written five times onto holographic storage medium 120 at three different power levels, namely, P1, P2, and P3, and the three power levels are preferably equidistant, where P1=P2⁻p, and P3=P2+p. The time-duration of the write pulse is T1, T2, and T3, and the three time-durations are preferably equidistant, where T1=T2⁻t, and T3=T2+t.

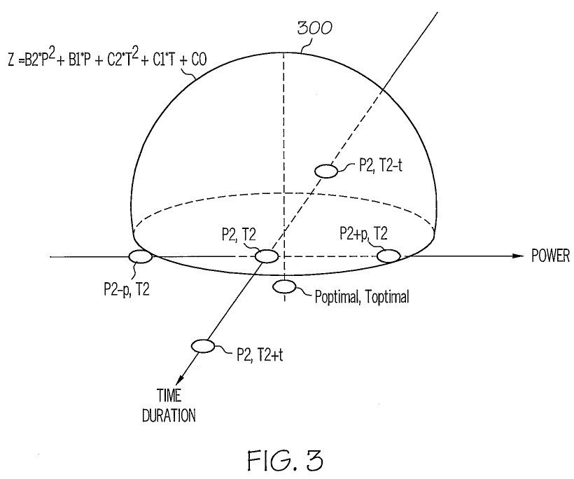

The quantification Z of each cross-correlation between write power level and time-duration for each of the five identical calibration holograms centered at P2,T2 is listed in Table I and graphically illustrated in FIG. 3. FIG. 3 depicts a three-dimensional (3D) ellipsoidal parabola 300 being a least-square fit to the cross-correlations of the calibration holograms to a matched filter of an ideal version of that calibration hologram. The power and time derivatives of 3D ellipsoidal parabola 300 are set to zero in order to determine an optimal write power level (Pₒₚₜ) and an optimal pulse time duration (Tₒₚₜ). A set of second derivatives is then utilized to test for the convex curvature of 3D ellipsoidal parabola 300 in order to insure that the calculated optimal power Pₒₚₜ along with the calculated optimal pulse time-duration Tₒₚₜ are indeed optimal.

TABLE I

| Correlation | Power | Time-duration |
|---|---|---|
| Z(−p, 0) | P1 = P2 − p | T2 |
| Z(0, 0) | P2 | T2 |
| Z(p, 0) | P3 = P2 + p | T2 |
| Z(0, −t) | P2 | T1 = T2 − t |
| Z(0, t) | P2 | T3 = T2 + t |

The following calculations are then performed between each calibration hologram 122 read from the holographic storage medium 120 as g(x,y) and a matched filter is utilized to match the impulse response h(x,y)=s*(−x,−y) of that same image previously stored in a system memory of the holographic drive, according to equation (1), as shown in block 206.

V(x,y)=∫∫g(ξ, η)s*(ξ−x, η−y)]dξdη (1)

V(x,y) in equation (1) is the cross-correlation between the data hologram read from the holographic storage medium g(x,y) and the ideal (perfect) image s(x,y) stored in the system memory of the optical drive. Directions x and y represent orthogonal axes on optical detector 130, and ξ, η represent integration variables. The correlation V(x,y) is quantified as the average Z for each of the five calibration holograms, as shown in Table I. Z could alternately represent the geometric mean, harmonic mean, or root-mean-square quantification of V(x,y).

The process of subtracting P2 from the above-mentioned power levels, subtracting T2 from the above-mentioned time-durations, and adding them back later (in equations (11)-(12)) will give the following five data points Z that are utilized in the ellipsoidal-parabolic least-square fit of the incremental optimal write power and power-pulse time-duration. The equation for a 3D ellipsoidal parabola 300, as shown in FIG. 3, is given by equation (2), where P denotes the laser write power; and power coefficients B1, and B2 as well as time-duration coefficients C1 and C2, and offset C0 are the unknowns that need to be solved.

Z=B2*P²+B1*P+C2*T²+C1*T+C0 (2)

The least-square equations are given in equation (3), where N=5 (three different power levels and 3 different time-differences are utilized for five correlations). The p and p³ terms are zero because of the known and equidistant incremental powers +p and −p.

Similarly, the t and t³ terms are zero, because of the known and equidistant incremental powers +t and −t.

$$\begin{matrix}C 0 * N & + C 1 * Σ t & + C 2 * Σ {t}^{2} & + B 1 * Σ p & + B 2 * Σ {p}^{2} & = Σ Z \\ C 0 * Σ t & + C 1 * Σ {t}^{2} & + C 2 * Σ {t}^{3} & + B 1 * Σ t * p & + B 2 * Σ t * {p}^{2} & = Σ Z * t \\ C 0 * Σ {t}^{2} & + C 1 * Σ {t}^{3} & + C 2 * Σ {t}^{4} & + B 1 * Σ {t}^{2} * p & + B 2 * Σ {t}^{2} * {p}^{2} & = Σ Z * {t}^{2} \\ C 0 * Σ p & + C 1 * Σ t * p & + C 2 * Σ {t}^{2} * p & + B 1 * Σ {p}^{2} & + B 2 * Σ {p}^{3} & = Σ Z * p \\ C 0 * Σ {p}^{2} & + C 1 * Σ t * {p}^{2} & + C 2 * Σ {t}^{2} * {p}^{2} & + B 1 * Σ {p}^{3} & + B 2 * Σ {p}^{4} & = Σ Z * {p}^{2}\end{matrix} \qquad ( 3 )$$

This produces matrix equation (4), with unknowns C0, C1, C2, B1, and B2. All other items in equation (4) are known. The matrix on the left-hand side has many zeroes due to the subtraction of P2 from the three power levels and T2 from the three time-durations, which greatly simplifies the matrix algebra in equation (4).

$$\begin{matrix}\vert & 5 & 0 & 2 {t}^{2} & 0 & 2 {p}^{2} & \vert \vert & C 0 & \vert \\ \vert & 0 & 2 {t}^{2} & 0 & 0 & 0 & \vert \vert & C 1 & \vert \\ \vert & 2 {t}^{2} & 0 & 2 {t}^{4} & 0 & 0 & \vert \vert & C 2 & \vert \\ \vert & 0 & 0 & 0 & 2 {p}^{2} & 0 & \vert \vert & B 1 & \vert \\ \vert & 2 {p}^{2} & 0 & 0 & 0 & 2 {p}^{4} & \vert \vert & B 2 & \vert\end{matrix} = \begin{matrix}\vert & Σ Z & \vert \\ \vert & Σ Z * t & \vert \\ \vert & Σ Z * {t}^{2} & \vert \\ \vert & Σ Z * p & \vert \\ \vert & Σ Z * {p}^{2} & \vert\end{matrix} \qquad ( 4 )$$

By solving equation (4) for C1 and B1 (since they involve one equation and one unknown), as shown in block 208 of FIG. 2, equations (5a)-(5b) are obtained:

C1=[Z(0,t)−Z(0,−t)]/2t (5a)

B1 =[Z(p,0)−Z(−p,0)]/2p (5b)

This leaves the following three equations and three unknowns to be solved for C0, C2, and B2, as listed in equation (6).

$$\begin{matrix}\vert & 5 & 2 {t}^{2} & 2 {p}^{2} & \vert \vert & C 0 & \vert \\ \vert & 2 {t}^{2} & 2 {t}^{4} & 0 & \vert \vert & C 2 & \vert \\ \vert & 2 {p}^{2} & 0 & 2 {p}^{4} & \vert \vert & B 2 & \vert\end{matrix} = \begin{matrix}\vert & Σ Z & \vert \\ \vert & Σ Z * {t}^{2} & \vert \\ \vert & Σ Z * {p}^{2} & \vert\end{matrix} \qquad ( 6 )$$

The determinant of the symmetric 3×3 coefficient matrix in the left-hand-side of equation (6) is 4*t⁴*p⁴. By applying Cramer's rule to solve equation (6), the solution for C2 can be obtained as

C2={6*p⁴*t²*[Z(0,t)+Z(0,−t)]−4*t²*p⁴*ΣZ+4*p⁴*t²*[Z(p,0)+Z(−p,0)]}/4*t⁴*p⁴

giving:

C2={3*[Z(0,t)+Z(0,−t)]−2*ΣZ+2*[Z(p,0)+Z(−p,0)]}/2*t² (7a)

Simplifying, the final expression for C2 is obtained:

C2=[Z(0,t)−2*Z(0,0)+Z(0,−t)]/2*t² (7b)

### Similarly,

B2={4*p²*t⁴*[Z(0,t)+Z(0,−t)[−4*t⁴*p²*ΣZ+6*p²*t⁴*Z(p,0)+Z(p,0)]}/4*t⁴*p⁴

giving

B2={2*[Z(0,t)+Z(0,−t)−2*ΣZ+3*[Z(p,0)+Z(−p,0)]}/2*p² (8a)

Simplifing, the final expression for B2 is obtained:

B2=[Z(p,0)−2*Z(0,0)+Z(−p,0)]/2*p² (8b)

Solving for partial derivative dZ/dp in equation (2) and setting that to zero yields the value of the incremental optimal write power, p, equation (7), provided that B2<0 in block 210 in FIG. 2. The condition that B2<0 comes from the second partial derivative of the ellipsoidal parabola being negative to insure that the calibration is indeed optimal.

Incremental optimal write power=−B1/(2*B2) (9)

Solving for partial derivative dZ/dt in equation (2) and setting that to zero gives the value of the incremental optimal time-duration, equation (7), provided that C2<0 in block 214 in FIG. 2. The condition that C2<0 comes from the second partial derivative of the ellipsoidal parabola being negative to insure that the calibration is indeed optimal.

Incremental optimal write pulse time-duration=−C1/(2*C2) (10)

Since C0 is not used in any of these calculations, its value is not needed from equation (4). This gives the desired optimal write power and time-duration, as shown in equations (11)-(12) and in block 218 in FIG. 2.

Pₒₚₜ=P2−B1/(2*B2) (11)

Tₒₚₜ=T2−C1/(2*C2) (12)

If B2≧0 in equation (8b), the process proceeds to block 212, and if correlation Z(p,0)>Z(−p,0), the drive picks power P4=P3+p and re-performs block 204 for powers P2, P3, P4, only now center power P3 is subtracted to obtain the incremental optimal power. Otherwise, the drive picks power P0=P1−p and re-performs block 204 for powers P0, P1, P2, only now center power P1 is subtracted to obtain the incremental optimal power.

If C2≧0 in equation (7b), the process proceeds to block 216, and if correlation Z(0,t)>Z(0,−t), the drive picks power T4=T3+t and re-performs block 304 for times T2, T3, T4, only now center time T3 is subtracted to obtain the incremental optimal power. Otherwise, the drive picks time T0=T1−t and re-performs block 204 for times T0, T1, T2, only now center time T1 is subtracted to obtain the incremental optimal power.

As has been described, the present invention provides a method for performing write calibrations on holographic storage media. The method of the present invention insures that a laser write pulse is optimal for a given removable holographic storage media with consideration to its age, temperature, etc. The method of the present invention is applicable to holographic storage media, holographic storage drives, and the interaction between the holographic storage media and the holographic storage drive comprising the write calibration process.

While an illustrative embodiment of the present invention has been described in the context of a fully functional holographic storage device, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD-ROM, CD-R, CD-RW, DVD-ROM, DVD-R, DVD-RW, and transmission communication protocols such as fibre channel, Ethernet, gigabit Ethernet, fibre channel over Ethernet, SCSI (small computer system interface), iSCSI (Internet SCSI), Infiniband, etc.

While the invention has been particularly shown and described with reference to a preferred embodiment, it will be understood by those skilled in the art that various changes in form and detail may be made therein without departing from the spirit and scope of the invention.

What is claimed is:

1. A method for performing write calibration on a holographic storage medium, said method comprising:
writing five identical calibration holograms on said holographic storage medium, wherein three of said five calibration holograms are written with different laser power levels and three of said five calibration holograms are written with different time durations;
utilizing a matched filter to determine a cross-correlation between each of said five hologram data read from said holographic storage medium and an ideal hologram;
quantifying each of said cross-correlations;
performing a least squares fit of said quantifications of said cross-correlations to an ellipsoidal parabola, to yield an optimal laser write power and an optimal duration for a laser write pulse.

2. The method of claim 1, wherein said three power levels are equidistant, and said three time durations are equidistant.

3. The method of claim 1, wherein said quantifications are chosen from an average, a geometric mean, a harmonic mean, or a root-mean-square.

4. The method of claim 1, wherein said method further includes storing said ideal hologram within said holographic storage medium.

5. The method of claim 1, wherein said method further includes storing said ideal calibration hologram within a holographic storage drive that utilizes said holographic storage medium.

6. The method of claim 1, wherein said holographic storage medium is a transmissive or a reflective holographic storage medium.

7. A computer readable storage medium having a computer program product for performing write calibrations on holographic storage media, said computer readable storage medium comprising:
computer program code for writing five identical calibration holograms on a holographic storage medium, wherein three of said five calibration holograms are written with different laser power levels and three of said five calibration holograms are written with different time durations;
computer program code for utilizing a matched filter to determine a cross-correlation between each of said five calibration holograms read from said holographic storage medium and an ideal calibration hologram;
computer program code for quantifying each of said cross-correlations; and
computer program code for performing a least-squares fit of said quantifications of said cross-correlations to an ellipsoidal parabola to yield an optimal laser write power level and an optimal duration for a laser write pulse.

8. The computer readable storage medium of claim 7, wherein said three power levels are equidistant, and said three time durations are equidistant.

9. The computer readable storage medium of claim 7, wherein said quantifications are chosen from an average, a geometric mean, a harmonic mean, or a root-mean-square.

10. The computer readable storage medium of claim 7, wherein said computer readable storage medium further includes computer program code for storing said ideal hologram within said holographic storage medium.

11. The computer readable storage medium of claim 7, wherein said computer readable storage medium further includes computer program code for storing said ideal calibration hologram within a holographic storage drive that utilizes said holographic storage medium.

12. The computer readable storage medium of claim 7, wherein said holographic storage medium is a transmissive or a reflective holographic storage medium.
